(19) United States
(12) Patent Application Publication
(10) Pub. No.: US 2003/0233638 A1
(43) Pub. Date: Dec. 18, 2003

(54) Memory allocation system for compiler

(76) Inventor: Kiyoshi Negishi, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/460,214

(22) Filed: Jun. 13, 2003

(30) Foreign Application Priority Data
Jun. 13, 2002 (JP) 2002-173179

(51) Int. Cl. G06F 9/45; G06F 12/00

(52) U.S. Cl. 717/140; 711/118; 717/150

(57) ABSTRACT

A memory allocation system for a compiler capable of realizing high speed processing by efficiently utilizing a cache memory. The memory allocation system for a compiler which analyzes an input source program and generating an object program, wherein the compiler includes: a parse unit for parsing an array appearing in the source program and outputting a parsed array; an array group registration unit for grouping arrays to be sequentially accessed in a process loop and registering a generated array group; and an array group reconfiguring unit for reconfiguring the array parsed by the parse unit, in accordance with the registered array group.

### BACKGROUND OF THE INVENTION

1. Field of the Invention

The present invention relates to a memory allocation system for a compiler, and more particularly to a memory allocation system for a compiler capable of efficiently disposing arrays on the memory.

2. Description of the Related Art

In a conventional high speed computer, memory accesses are localized to effectively use a cache memory and realize a high speed process. For example, when an optimized compiler executes a loop of sequentially accessing a plurality of arrays, accesses to the arrays are localized through vectorization to realize high speed processing of a program by effectively utilizing a cache memory.

If an object to be accessed is not arrays but variables, a plurality of variables to be accessed at the same time are allocated on the memory at near addresses to localize memory accesses and realize high speed processing. For example, the Publication JP-A-7-129410 (Memory Allocation System for Compiler) discloses that a plurality of variables frequently used by portions of a program having a large number of execution times are allocated in the memory at addresses as near as possible.

According to the related art described above, memory accesses can be localized by changing the memory allocation of variables. However, each of arrays occupies a large memory capacity so that the arrays cannot be disposed in the memory at near addresses and accesses cannot be localized, as opposed to the case of variables.

If there is dependency among arrays and vectorization cannot be adopted, localized memory accesses cannot be realized. The cache memory cannot therefore be used effectively.

### SUMMARY OF THE INVENTION

The invention has been made to solve the above problem. It is an object of the present invention to provide a memory allocation system for a compiler capable of effectively utilizing a cache memory and realizing high speed processing.

The present invention adopts the following means in order to solve the above-described problem.

A memory allocation system for a compiler which analyzes an input source program and generating an object program, wherein the compiler includes: a parse unit for parsing an array appearing in the source program and outputting a parsed array; an array group registration unit for grouping arrays to be sequentially accessed in a process loop and registering a generated array group; and an array group reconfiguring unit for reconfiguring the array parsed by the parse unit, in accordance with the registered array group.

### BRIEF DESCRIPTION OF THE DRAWINGS

FIG. 1 is a diagram showing the structure of a compiler according to an embodiment of the invention.

FIG. 2 is a diagram showing a source program.

FIG. 3 is a diagram showing a symbol table.

FIG. 4 is a diagram illustrating intra-loop array information.

FIG. 5 is a diagram showing an array group table.

FIG. 6 is a diagram showing a grouped symbol table.

FIG. 7 is a diagram illustrating a process of generating intra-loop array information.

FIG. 8 is a diagram illustrating a process to be executed by an array group registration unit.

FIG. 9 is a diagram illustrating a process to be executed by an array group reconfiguring unit.

FIG. 10 is a diagram illustrating the effects of a conventional system.

FIG. 11 is a diagram illustrating the effects of an embodiment system.

### DESCRIPTION OF THE EMBODIMENTS

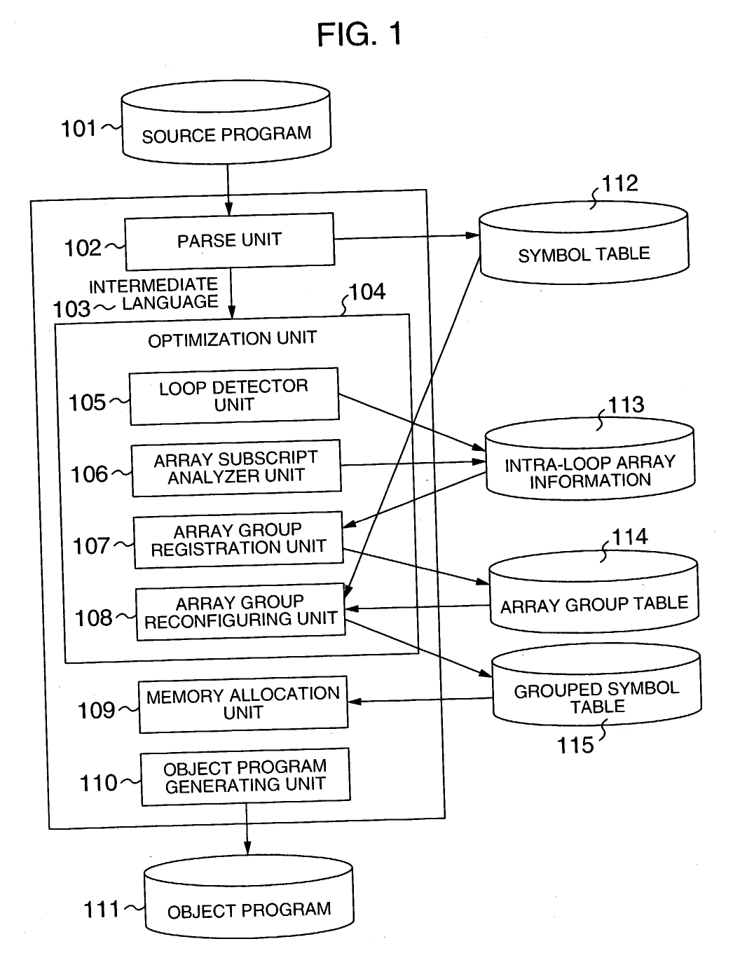

An embodiment of the invention will be described with reference to the accompanying drawings. FIG. 1 shows the structure of a compiler according to an embodiment.

A parse unit 102 receives a source program 101 and parses the program to generate a symbol table 112 of variables and arrays appearing in the source program and also generate intermediate language (intermediate language used when the source program is compiled) 103. The parse unit 102 sends the generated intermediate language to an optimization unit 104.

The optimization unit 104 has a loop detector unit 105, an array subscript analyzer unit 106, an array group registration unit 107 and an array group reconfiguring unit 108. The loop detector unit 105 analyzes the intermediate language 103 to detect any loop in the program. Namely, in cooperation with the loop detector unit 105, the array subscript analyzer unit 106 analyzes the subscript of an array appearing in the loop. In this manner, information on an array used in the loop and information on which subscript refers to the array can be output as intra-loop array information 113.

The array group registration unit 107 collects arrays used in the loop at the same time as a group, by referring to the intra-loop array information 113, and outputs the collected arrays as an array group table 114. By referring to the array group table 114, the array group reconfiguring unit 108 reconfigures as one structural body the arrays registered in the symbol table 112, and outputs the structural body as a grouped symbol table 115.

By referring to the grouped symbol table 115, a memory allocation unit 109 allocates variables and arrays on a memory. An object program generating unit 110 outputs an object program 111 as a final output of the compiler.

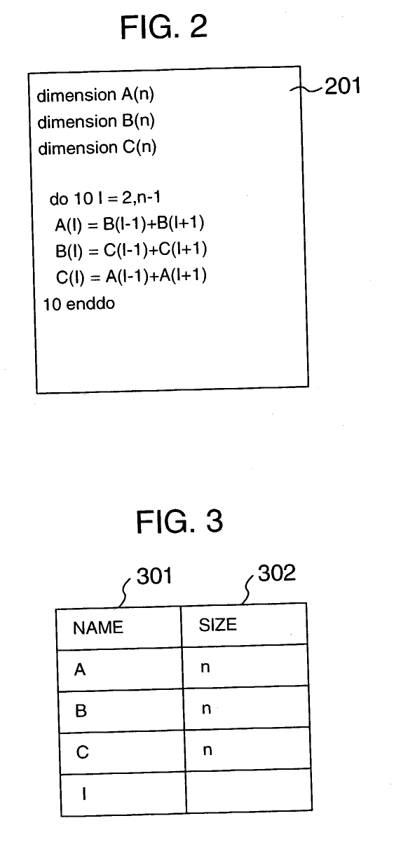

FIG. 2 shows a FORTRAN source program 201 as one example of the source program. As shown, this program 201 has arrays A, B and C. Each array uses a value defined by repetition of a DO loop, i.e., a value defined by a preceding repetition and a succeeding repetition. There is dependency between the arrays so that vectorization is impossible. Therefore, the DO loop is executed by sequentially executing statements described in the loop.

FIG. 3 is a diagram showing the symbol table 112 generated by parsing the FORTRAN source program 201 shown in FIG. 2 by the parse unit 102 shown in FIG. 1. As shown, the symbol table 112 stores therein the names 301 of the arrays (A, B, C) and a variable (I) to be used in the program, and the size 302 of the arrays. The field of the size (n) 302 of the variable is not used.

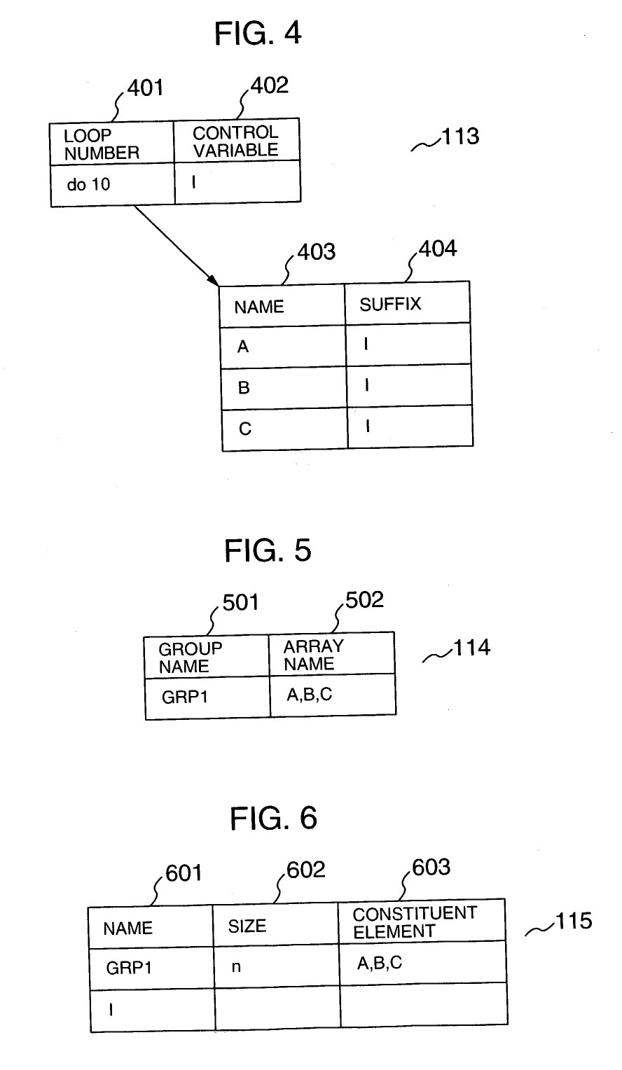

FIG. 4 is a diagram showing the intra-loop array information 113. The intra-loop array information, which is array information used by one loop, is constituted of a loop number 401, a control variable 402 used by the loop, the names 403 of the arrays defined in the loop, and subscripts 404 used by the arrays.

FIG. 5 is a diagram showing the array group table 114. The array group table 114 is constituted of a group name 501 and an array name 502 belonging to the group. The array group table 114 shows a group of collection of a plurality of arrays used in the loop at near positions thereof, and the group name.

FIG. 6 is a diagram showing the grouped symbol table 115. The grouped symbol table 115 is formed by reconfiguring the symbol table 112 shown in FIG. 3, based on the array group table 114 shown in FIG. 5. The grouped symbol table 115 is constituted of a group name 601, a size 602 and a constituent element 603. The size 602 is the maximum value (n) of the sizes of grouped arrays A, B, and C.

As described earlier, the memory allocation unit 109 performs memory allocation by referring to the grouped symbol table 115. The group name 601 is assigned the structural body having the constituent elements 603. The terms “intermediate word” and “symbol table” are general technical terms for a compiler, the details of which are described, for example, in a document “Programming Language Processing System”, by Saga Mastitic, Ainhum Shorten Publishers, 1989.

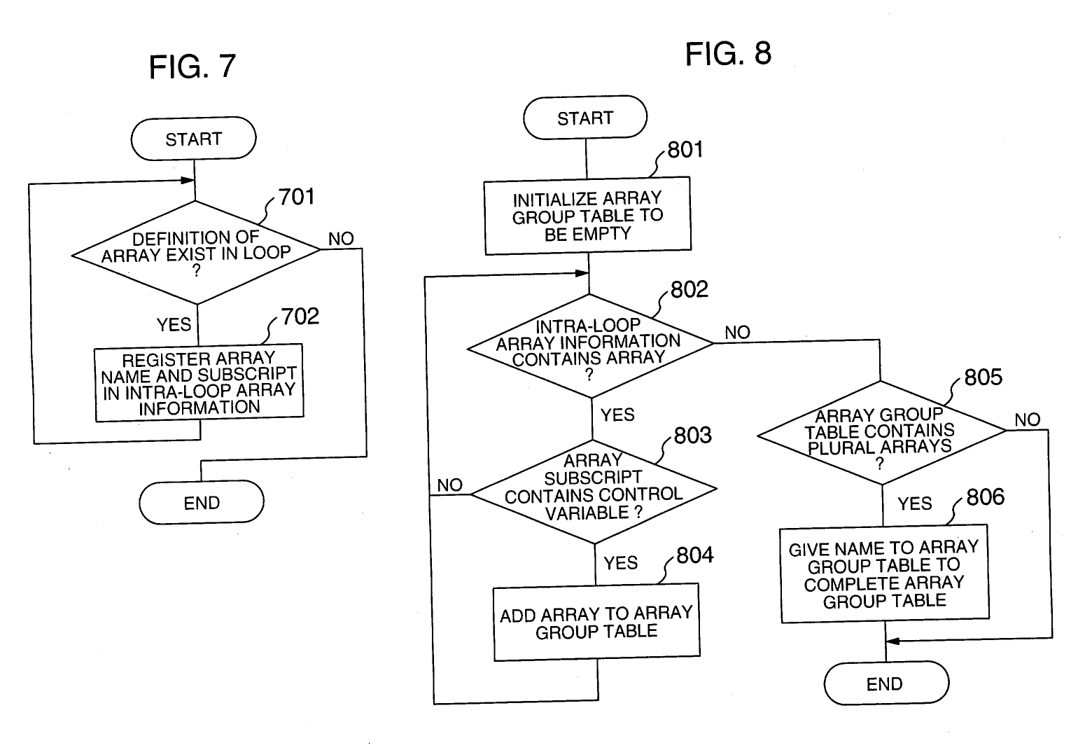

FIG. 7 is a flow chart illustrating a process of generating the intra-loop array information 113. First, it is checked (Step 701) whether the definition of an array exists in each loop detected by the loop detector unit 105 shown in FIG. 1. If the definition of an array exists, its array name and subscript are output as the intra-loop array information 113 and stored in a memory or the like. The method of detecting a loop and the method of parsing a subscript can be realized by well-known techniques regarding optimization of a compiler, and are described, for example, in the above-cited documentation.

FIG. 8 is a diagram illustrating a process to be executed by the array group registration unit 107 shown in FIG. 1. The array group registration unit 107 processes the intra-loop array information 113 shown in FIG. 4 in the following manner to acquire the array group table 114 shown in FIG. 5.

First, as initial setting, the array group table 114 is made empty (Step 801). Next, it is checked (Step 802) whether any array is registered in the intra-loop array information 113. If registered, it is checked (Step 803) whether the subscript of the registered array contains a control variable. If it contains, it means that the registered array has a subscript which increments each time the loop is repeated. Namely, the array is sequentially accessed in the loop. This array is registered in the array group table 114 to thereafter returns to Step 802 (Step 804). If it is judged at Step 803 that the array subscript does not contain a control variable, the flow returns to Step 802 (without registering the array in the array group table).

If the array or arrays registered in the intra-loop array information 113 are processed all at Step 802, the flow advances to Step 805 whereat it is checked whether the array group table 114 registers a plurality of arrays. If a plurality of arrays are registered in the array group table, a name is given to the array group table 114 to complete the array group table (Step 806). If the array group table 114 is empty or it registers only one array, the array group table 114 is not formed.

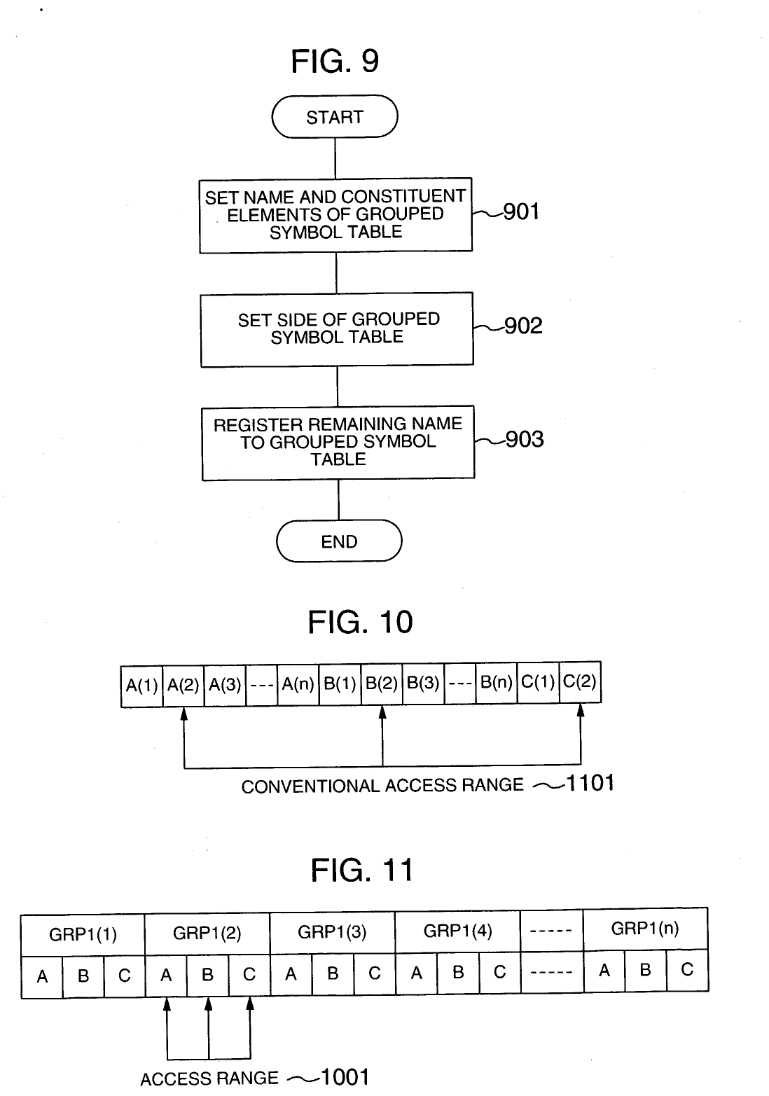

FIG. 9 is a diagram illustrating the process to be executed by the array group reconfiguring unit 108 shown in FIG. 1. The array group reconfiguring unit 108 processes the symbol table 112 shown in FIG. 3 in the following manner, based on the array group table shown in FIG. 5, to thereby acquire the grouped symbol table 115 shown in FIG. 6.

A group name and array names are derived from the array group table 114 generated by the array group registration unit 107 shown in FIG. 1, and set to the grouped symbol table 115 as its name and constituent elements (Step 901). Next, an entry having the name of each constituent element is searched from the symbol table 112 generated by the parse unit 102 shown in FIG. 1 to acquire the sizes of the entry to set the maximum size in the grouped symbol table 115 (Step 902). A name (variable) not contained in the group is derived from the symbol table 112 and set to the grouped symbol table 115 (Step 903). The grouped symbol table 115 generated in this manner shows the structural body array GRP1 having a size n and the arrays A, B and C as the constituent elements. A normal memory allocation can be applied to such a structural body array.

FIGS. 10 and 11 are diagrams illustrating the effects of this embodiment. FIG. 10 is a diagram showing memory allocation and a memory access range when the FORTRAN source program shown in FIG. 2 is subjected to a conventional memory allocation method. As shown, for example, arrays A(2), B(2) and C(2) to be accessed at the same time is dispesively disposed. If each element of the arrays A, B and C has an m-byte length, the access range is 2n×m bytes. As the number of constituent elements of an array becomes larger, the access range becomes broader, lowering an access efficiency.

FIG. 11 is a diagram showing memory allocation and a memory access range when the FORTRAN source program shown in FIG. 2 is subjected to the embodiment memory allocation method. As shown, the arrays A, B and C of the FORTRAN source program shown in FIG. 2 are reconfigured as the structural body array GRP1 and allocated on the memory. The arrays A(2), B(2) and C(2) of the FORTRAN source program shown in FIG. 2 to be accessed at the first repetition of the DO loop are localized in the access range 1001. Assuming that each element of the arrays A, B and C has an m-byte length, the access range is 3×m bytes. This range is constant irrespective of the number n of constituent elements.

As described so far, according to the embodiment, when a plurality of arrays in a loop is sequentially accessed, memory accesses can be localized so that the performance of a cache memory can be maximized and high speed processing of a program can be realized.

As described above, according to the present invention, it is possible to provide a memory allocation system for a compiler capable of effectively utilizing a cache memory and realizing high speed processing.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A memory allocation system for a compiler which parses an input source program and generates an object program, the compiler comprising:
a parse unit for parsing an array appearing in the source program and outputting a parsed array;
an array group registration unit for grouping arrays to be sequentially accessed in a process loop and registering a generated array group; and
an array group reconfiguring unit for reconfiguring the array parsed by said parse unit, in accordance with the registered array group.

2. A memory allocation system for a compiler which parses an input source program and generates an object program, the compiler comprising:
a parse unit for parsing an array appearing in the source program and outputting a parsed array;
an array group registration unit for grouping arrays to be sequentially accessed in a process loop and registering a generated array group;
an array group reconfiguring unit for reconfiguring the array parsed by said parse unit, in accordance with the registered array group; and
memory allocation means for allocating the array on a memory, in accordance with the array reconfigured by said array group reconfiguring unit.

3. A memory allocation system for a compiler which parses an input source program and generates an object program, the compiler comprising:
a parse unit for parsing an array appearing in the source program and outputting a parsed array;
an array group registration unit including a loop detector unit for detecting an array to be sequentially accessed in a process loop and a subscript analyzer unit for analyzing a subscript used by the array, said array group registration unit grouping arrays to be sequentially accessed in the process loop and registering a generated array group, in accordance with results obtained by said loop detector unit and said subscript analyzer unit;
an array group reconfiguring unit for reconfiguring the array parsed by said parse unit, in accordance with the registered array group; and
memory allocation means for allocating the array on a memory, in accordance with the array reconfigured by said array group reconfiguring unit.

4. A memory allocation system for a compiler which parses an input source program and generates an object program, the compiler comprising:
means for detecting a plurality of arrays to be sequentially accessed in a process loop; and
means for reconfiguring a plurality of detected arrays in one array group.

5. A memory allocation system for a compiler which parses an input source program and generates an object program, the compiler comprising:
means for detecting a plurality of arrays to be sequentially accessed in a process loop;
means for reconfiguring a plurality of detected arrays in one array group; and
memory allocation means for allocating the array on a memory in accordance with the reconfigured array group.

6. A compiler for a computer parsing an input source program to generate an object program comprising the steps running on the computer, the steps comprising the units for:
parsing an array appearing in the source program and outputting a parsed array;
grouping arrays to be sequentially accessed in a process loop and registering a generated array group; and
reconfiguring the array parsed by said parse unit, in accordance with the registered array group.

7. A compiler according to claim 6, wherein the steps further comprises the units for:
reconfiguring the array parsed by said parse unit, in accordance with the registered array group; and
allocating the array on a memory, in accordance with the array reconfigured by said array group reconfiguring unit.

8. A method materialized in a computer parsing an input source program to generate an object program comprising the steps of:
parsing an array appearing in the source program and outputting a parsed array;
grouping arrays to be sequentially accessed in a process loop and registering a generated array group; and
reconfiguring the array parsed by said parse unit, in accordance with the registered array group.

9. A method according to claim 8, further comprising the steps of:
reconfiguring the array parsed by said parse unit, in accordance with the registered array group; and
allocating the array on a memory, in accordance with the array reconfigured by said array group reconfiguring unit.
